(19) United States
(12) Patent Application Publication
(10) Pub. No.: US 2002/0044558 A1
(43) Pub. Date: Apr. 18, 2002

(54) Distributed IP over ATM architecture

(75) Inventors: Richard L. Gobbi, Potomac, MD (US); Faris Faris, Bethesda, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Astrolink International, LLC

(21) Appl. No.: 09/976,271

(22) Filed: Oct. 15, 2001

Related U.S. Application Data
(60) Provisional application No. 60/239,883, filed on Oct. 13, 2000.

(51) Int. Cl. H04L 12/28; G06F 15/16

(52) U.S. Cl. 370/395.52; 370/310.1; 370/395.1; 709/249

(57) ABSTRACT

The invention provides for the transmission IP data over an ATM switch architecture in a communications network. The invention provides for a distributed communication system that includes a user terminal for generating and processing user data in a connectionless format, a relay node communicatively connected to the user terminal, the relay node supporting a connection-oriented operation functionality and a gateway communicatively connected to the relay node for managing the interface between the user terminal and the relay node.

### CROSS REFERENCE TO RELATED APPLICATIONS

This application claims priority from U.S. Provisional Patent Application No. 60/239,883 entitled, DISTRIBUTED IP OVER ATM ARCHITECTURE FOR SATELLITES, filed on Oct. 13, 2000, the entirety of which is herein incorporated by reference.

### BACKGROUND OF THE INVENTION

1. Field of the Invention

The invention relates generally to a system and method for network data communication. More particularly, the invention provides for the transmission of data in the Internet Protocol (IP) format over an Asynchronous Transfer Mode (ATM) architecture utilizing a communication system

2. Description of Related Art

The convergence of communication satellite technology with the evolving technology of the global Internet and the World Wide Web will result in satisfaction of the need for high-bandwidth interconnection to a geographically dispersed consumer and business enterprise market base. This interconnection capability, provided via satellite, will support Internet services using a variety of methods.

The Internet Protocol (IP) is a connectionless protocol wherein the network addresses of source and destination hosts are carried in the IP packet. The hosts are connected by a series of routers. Routers operate on the packets using physical layer, link layer, and network (i.e., IP) layer information. Each router has two basic functions to apply to each packet: Packet forwarding and packet routing. The packet forwarding function uses a lookup table which identifies the physical interface of the next hop router toward the destination based upon appropriate bits of the IP subnet address structure. This subnet structure allows summarization of host addresses to keep routing table size down. The packet routing function determines the best route from the current router to the destination host based on an assumed cost function (e.g., based on link capacity, link congestion or monetary cost of the hops). The result of the packet routing computation at the current router is the filling of the next hop forwarding table for the packet.

The original concept of the Internet Protocol is that these two function, packet routing and packet forwarding, are carried out at each router for all packets through the router. As the Internet grew, and more and more expensive processing was brought to bear on the packet routing problem, designers began to look at the simpler packet switching function carried out in connection-oriented protocols such as the Asynchronous Transfer Mode (ATM). In ATM, the routing function is carried out before the end-to-end connection is established via connection (or call) control signaling carried out in the ATM control plane. This transfers much of routing the complexity to the control plane.

Each fixed-size, 53-byte ATM packet, called a cell, has a 5-byte header which includes a field called a VPI/VCI (virtual path indicator/virtual channel indicator). These are labels that have local significance between two switches along the path between the source and the destination. A switch maps an input VPI/VCI to an output VPI/VCI based on a VPI/VCI connection map between switch input and output. All endpoint address information, and the mapping of this information to VPI/VCI labels along paths between switches, is carried out by the ATM control layer.

A connection-oriented protocol for satellite systems enables the use of simple, easily built, fast packet switches on-board the satellites in that routing and forwarding can be separated such that the routing function is relegated to software-upgradeable ground control stations. This is especially important because the integrated circuits for use at geosynchronous altitudes must be able to function with high levels of exposure to background radiation consisting most significantly of heavy ions due to a combination of solar radiation and cosmic background radiation. Such an environment is clearly an impediment to provide the full-mesh networking capability inherent in a geosynchronous satellite-based fast packet switching system wherein 40 percent of the earth's surface is covered by a single satellite. In this environment the need for minimization of processing functions on-board the satellite, as afforded by a connection-oriented protocol, is in many ways more pronounced than in high-speed terrestrial networks.

The choice of fixed-size packets, such as the cells of ATM, simplifies the structure on-board a satellite even further. The simple and fast address (e.g., ATM's VPI/VCI) switching capability inherent in such a packet choice further simplifies the processing to be carried out in the satellite.

Noting this complexity trade, Internet designers have developed connection-oriented label switching protocols that attain the packet forwarding simplicity of ATM applied to variable-length IP packets. These protocols require the development of the equivalent of the ATM control plane functions. These functions include the label management and distribution protocols developed by the Internet Engineering Task Force (IETF). The resulting set of standards is referred to as Multi-protocol Label Switching (MPLS).

A key feature of MPLS is the separation of the routing and forwarding functions. The result is a protocol that can scale to higher packet throughput networks without pushing the limits of router processing power. Additionally, MPLS can more easily support Quality-of-Service (QoS) than traditional IP, simply because it is connection-oriented, resulting in the fact that paths can be chosen before packets are transmitted.

Support of QoS is a defined goal in the development of the ATM standards. The ATM standards also have the goal of accommodating a variety of connectionless network layer protocols, including the de facto standard network layer protocol, IP. There are various ways of doing this, but, in application to wide area and backbone networks, Classical IP over ATM has been the mainstay for many years. It has limitations in that routers are required between Logical IP Subnetworks (LISs). This limitation does not allow for potentially more efficient ATM connections between nodes that are connected to the same ATM network but are members of different LISs. The solution to this problem is the Next Hop Resolution Protocol (NHRP) developed by the IETF. However, neither Classical IP over ATM nor NHRP include routing. Therefore, there is a need to develop address resolution protocols that bind IP addresses of sources and destinations to the associated node ATM addresses.

### SUMMARY OF THE INVENTION

Accordingly, the invention provides a communications network utilizing an IP over ATM architecture for geosynchronous satellites. This architecture is not limited to ATM cell switching satellites, but can be applied to any satellite link layer networking structure of the Non-Broadcast, Multi-Access (NBMA) type. These type of networks include, but are not limited to, ATM, Frame Relay, and SMDS.

The invention provides an IP over satellite capability enabled by transmitting link layer packets using a connection-oriented, NBMA network protocol, such as ATM, over a fast packet switching satellite. The invention requires two-way, transmit and receive, user terminals (UTs) to transmit and receive user IP packets over the link layer through the satellite. It also requires gateways (GWs), which are nothing more than specially-equipped user terminals. The added functionality of a gateway will be specified below.

In accordance with these features, the invention provides a communications system for transmitting the internet protocol over satellite-based fast packet switches using a link layer NBMA network protocol. The invention assumes satellite-based link layer packet switches and associated control plane and management plane infrastructure. The invention provides User Terminal IP routing, forwarding an IP-to-link layer address resolution client capability, the associated gateway (specialized User Terminal)-based functions of IP-to-link layer address resolution server capability and Route Server capability.

The invention further provides a distributed IP over ATM architecture for satellite systems. In accordance with the invention, the architecture is implemented in the edge devices, i.e., terminals and gateways, rather than in the satellite. In this manner, the invention protects the long-lived and unchangeable satellite ATM cell-switching capability from potential future enhancements required to support changes in the TCP/IP protocol suite, which runs over the satellite system through application of standard-based techniques. Additionally, it allows a mapping of IP differential services to the ATM quality of service classes.

The architecture of the invention also provides a natural function separation of IP routing from IP traffic forwarding.

### BRIEF DESCRIPTION OF THE DRAWINGS

The invention is described in relation to the following drawings, in which like reference symbols refer to like elements, and wherein:

FIG. 1 is a block diagram illustrating the distributed system for transmitting data in an IP format over an ATM architecture in accordance with an embodiment of the invention;

FIG. 2 is a block diagram of the system in accordance with an embodiment of the invention; and

FIG. 3 diagram illustrating the signaling and data flows for terminal packet forwarding in accordance with an embodiment of the invention.

### DETAILED DESCRIPTION OF PREFERRED EMBODIMENTS

Reference will now be made in detail to an embodiment of the present invention, examples of which are illustrated in the accompanying drawings.

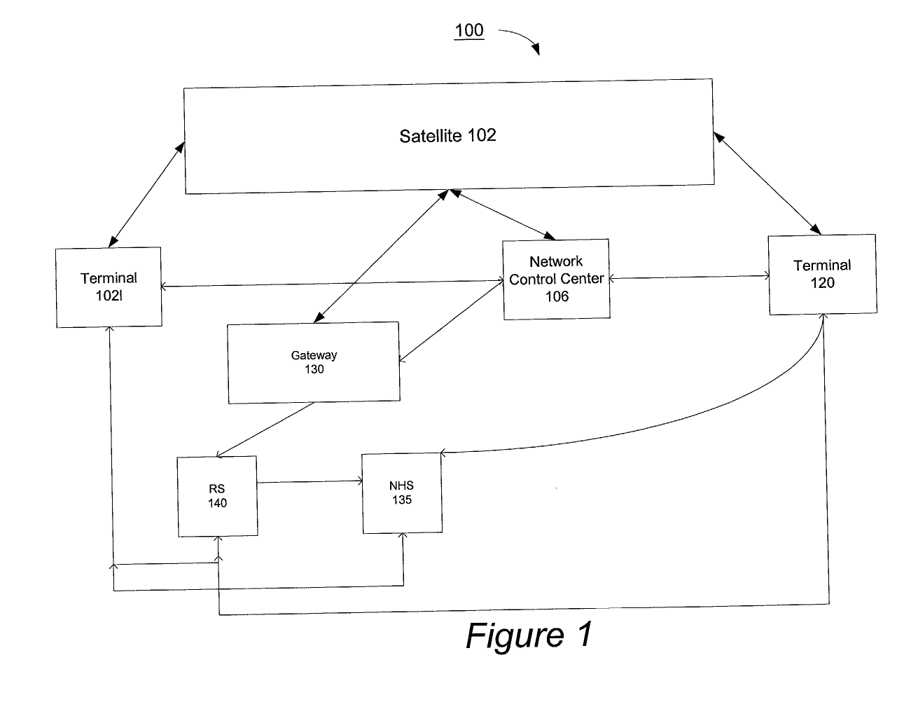

FIG. 1 shows the satellite network communication system 100 in accordance with one embodiment of the invention. The satellite network communication system 100 includes a satellite 102, a first ground based station, or terminal 104, a network control center 106 (NCC) and a second ground based station, or terminal 120. FIG. 1 also shows a gateway 130 coupled to a routing server (RS) 140 and a next hop server (NHS) 135 for controlling transmission of IP data over an ATM network between terminals 104 and 120.

The first ground based station 104 communicates with the network control center 106 and/or the second ground based station 120 via the satellite 102. ATM packets have fixed lengths and have routing codes, which may also be referred to as addresses even though they only have per-link significance, so that ATM packets having the same ultimate destination and routing codes are sent via a common virtual circuit. The end-to-end pairing of destinations is determined, in ATM, by control signaling to the NCC 106 prior to transmitting packets on a virtual circuit. The routing codes allow processing and switching of the packets at the first ground based station 104, at the ATM switch 112 and at the second ground based station 120. The routing codes also indicate the priority levels of the ATM packets so that the packets having higher priority are transmitted earlier, but in such a manner that no one virtual circuit is starved for bandwidth.

In accordance with one embodiment of the invention, the gateway 130 is provided in order to centralize the routing exchanges and address resolution functionality for the user terminals, thus, decreasing the inter-router exchange traffic from the user terminal. This functionality may be distributed across multiple gateways so as to obtain a realizable solution both from the gateway-to-satellite link capacity and the gateway computational viewpoints. Given the assumption that the satellite network is closed in the sense that all routing and address resolution control signaling must go through the satellite fast packet switch, the invention in accordance with this embodiment, may use multiple gateways for distributed control of the IP over NBMA (e.g., ATM) functions in a larger satellite network, helps minimize the amount of routing exchanges and address resolution interchanges that go over the satellite. In the case where routing is done only between the edge routers behind or inside the user terminals 104 and 120, the number of routing interchanges, as well as the number of associated address resolution interchanges, increases exponentially with the number of user terminals 104 and 120. Accordingly, the gateway 270 is able to reduce routing and addressing traffic from the user terminals 104 and 120 and thus advantageously centralizes this functionality and enhances IP throughout the satellite 102.

FIG. 1 also shows the RS 140 coupled to the gateway 130 and the NHS 135. Further, the RS 140 and the NHS 135 are both coupled to the user terminals 104 and 120.

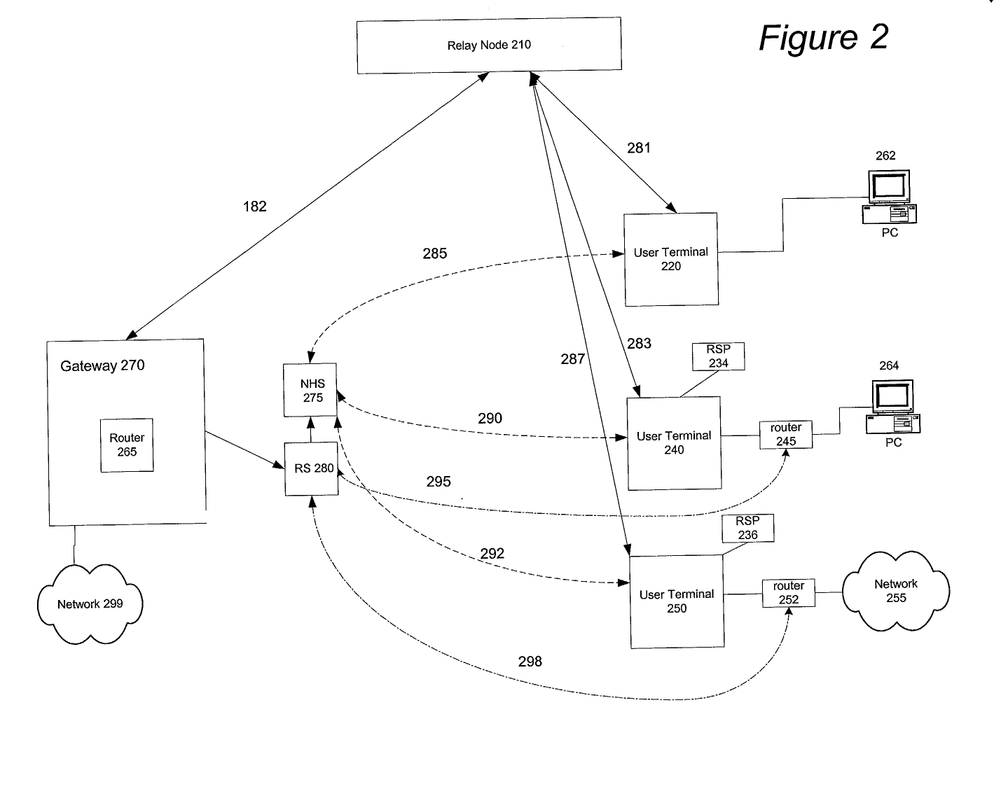

In operation, the gateway 130 receives routing interchange query packets from the terminal 104 and 120 via the satellite 102 and forwards the packets to the RS 140. The RS 140 facilitates the exchange of routing information among user terminal 104 and 120 connected routers (e.g., 240 and 250 in FIG. 2). Further, NHS 135 implements the necessary IP to ATM address resolution function using next hop resolution protocol (NHRP), classical IP over ATM, or other similar technologies for address resolution. The user terminals 104 and 120 provide next hop client (NHC) and RS proxy capabilities, which will be described in greater detail below. The invention is applicable to networks wherein part of the functionality is implemented by static, or manually updated lookup tables in the user terminals and gateway, as well as to full dynamic routing and address resolution capability. The functionality of the gateway 270, NHS 275 and RS 280 is described in greater detail in connection with FIG. 2 below.

FIG. 2 shows the architecture for transmitting IP data over an ATM network in accordance with an embodiment of the invention. FIG. 2 shows three user terminals 220, 240 and 250 communicatively coupled to a relay node 210 via communication links 281, 283 and 287. The relay node may be any communications carrier, for example a satellite, and may includes a switch. For illustrative purposes, the user terminals 220, 240 and 250 represent differing communications environments. For example, the user terminal 220 is communicatively coupled to a personal computer 262 via a local area network (LAN, not shown). The user terminal 240 is coupled to a PC 264 on a LAN (not shown) accessible via a router 245. The user terminal 250 is communicatively coupled to an external network 255 via a router 252.

A gateway 270 is communicatively coupled to the relay node 210 via a communications link 282. The gateway 270 includes a router 265 and is communicatively coupled to a network 299. In addition, the system of FIG. 2 also includes a RS 280 coupled to the gateway 270 and a NHS 275. All of the communications links 281, 282, 283 and 287 described above, are all connections via virtual circuits through the relay node 210.

In some cases, the user terminals 240 and 250 may provide standard Ethernet interfaces to routers that provide connectivity to external networks, subnetworks, or local area networks (LANs). In other cases, the user terminals 240 and 250 may be directly connected to host computers connected across a LAN. These cases are illustrated in FIG. 2 as described above. An application of the router 265 in the gateway 270 is to interconnect autonomous systems which may cover both satellite and terrestrial components (although the router in the gateway 270 of FIG. 2 need not so interconnect autonomous systems). Autonomous systems are systems of IP routers which use a common routing protocol, called an interior routing protocol (IRP). The interconnecting router 265, in this example inside a gateway 270, which passes routing information between routers in different autonomous systems, must use an exterior routing protocol (ERP).

One of the autonomous systems described above may be considered to be a Logical Network Group (LNG). The LNG designation ensures that that user terminals belonging to a single customer network can be clearly partitioned and the routing exchange for those terminals separated from the exchanges that occur among other LNGs operating across the system. FIG. 2 shows the IP address assignment and network configuration that may be implemented to support routing for a defined LNG.

The user terminal 250 and gateway 270 provide the necessary interface between the IP network elements 299 and 255 and the relay node 210 transport infrastructure. This architecture applies for the user terminals 220, 240 and 250 that support forwarding of packets based on dynamic analysis of IP destination address information. Static routing together with gateway 270 centered IP-to-NBMA, i.e. ATM, address resolution can be applied for user terminal networks in which pre-configured NBMA connections are used for forwarding IP traffic. In this example, a dynamic element is introduced in which a large number of user terminals can be interconnected with each user terminal employing a local cache to store recently-used IP/NBMA address bindings. This enables a scaling capability to larger numbers of user terminals in a static-routed environment. This technique could be used profitably in closed VSAT networks, for example.

In FIG. 2, the RS 280 may be a redundantly implemented network element that facilitates the dynamic routing exchanges between the user terminal-connected (or User terminal embedded) routers, e.g., 245 and 252. The dynamic routing exchanges allow the RS 280 to gather routing information from the user terminal-connected routers 245 and 252, process that information based on the routers' routing policy requirements, and pass the processed information to each of the routers that comprise the defined Logical Network Group (LNG). The RS 280 will create a Routing Information Base (RIB) associated with the user terminal-connected routers 245 and 252. The RIB for each LNG maintains routing information that reflects routing metric and configuration requirements of the particular routers of the LNG. The LNG is defined on the basis of IP routing policy which dictates the partitioning of the RS 280 and the particular interfaces through which network reachability information is exchanged. The RS 280 will also implement the particular routing protocols or links 298 and 295 required for the routing exchanges between the user terminal connected routers 252 and 245. Routes gathered by the RS 280 for a particular LNG are made available to the NHS 275 to facilitate address resolution, as described below.

In facilitating routing exchanges between user terminal-connected routers 245 and 252 and the RS 280, each user terminal 240 and 250 is configured to provide a local RS proxies 234 and 236, that interface to the externally connected routers 245 and 252. The IP protocol stack within the user terminals 240 and 250 will forward routing protocol exchanges to the RS 280 via routing protocol links 295 and 298.

In FIG. 2, the dynamic routing is supported at the user terminals 240 and 250 and at the gateway 270. For each user terminal connected router 245 and 252 that supports routing protocol exchanges, the RS 280 is assigned an IP address that is taken from the user terminal connected router interface. For each network that supports a router, there are three associated IP addresses: the router's IP address, the user terminal's IP address (taken from the assigned interface address), and the RS IP address (also assigned from the terminal-customer premise equipment (CPE) interface configuration). Within the embodiment shown in FIG. 2, the RS 280 is configured to have three different IP interface addresses: the router's IP address, the user terminal's IP address (taken from the assigned interface address), and the RS IP address (also assigned from the terminal-CPE interface configuration). The LNG definition allows the network to use the address assignments that may have been previously allocated.

Routing information is gathered at the RS 280 for each of the dynamic CPE routing interfaces and the aggregated information provided to each of the connected CPE routers, e.g., the routers 245 and 252, (and potentially the gateway router 265) subject to the routing policy specifications for the LNG. The RS IP address corresponding to the adjacent router is indicated as the next hop for advertised destination networks. A user may configure a single router only on the subnet connected to the user terminal for routing exchanges with the RS 280. For example, in the case of the user terminal 250, routing protocols are transmitted via link 298 between the CPE router 252 and the RS 280, where the user terminal 250 supports the forwarding proxy functions. The RS 280 may be configured to support open shortest path first (OSPF) for the interior routing protocol (IRP) among all sites of the LNG. Support for other IRPs, such as RIPv2 or IGRP, is allowed since standard routers can typically be configured to redistribute subnet routes from one IRP to another (e.g. RIP into and out of OSPF). This technique may be useful when a CPE network supports an IRP that the RS 280 does not support. For connectivity to the Internet, the RS 280 may inject some or all of the customer routes learned through the IRP into a ERP session, e.g., a Border Gateway Protocol (BGP) session, with the gateway router 265. The remote customer network in this case may use a default route towards the RS 280 to reach the Internet.

To establish direct connection paths between the user terminals 220, 240 and 250 for the forwarding of IP traffic, the user terminals 220, 240 amd 250 must be capable of performing IP-to-ATM address resolution. Once the user terminal ATM address has been determined for an IP packet, a virtual connection can be established between the originating and terminating user terminals. The Next Hop Resolution Protocol (NHRP) provides the mechanisms for address resolution performed by the user terminals 220, 240 and 250 over their satellite interfaces, as shown by the links 285, 290 and 292. Upon receipt of an IP packet over the local Ethernet interface, the user terminal first checks its local cache to determine whether an ATM address currently exists for the particular IP address destination. If a resolution for the address is not locally cached, the Next Hop Client (NHC) within the terminal will transmit a NHRP request to the NHS 275. The NHS 275 will be responsible for performing the address resolution and returning an appropriate ATM address to the requesting NHC.

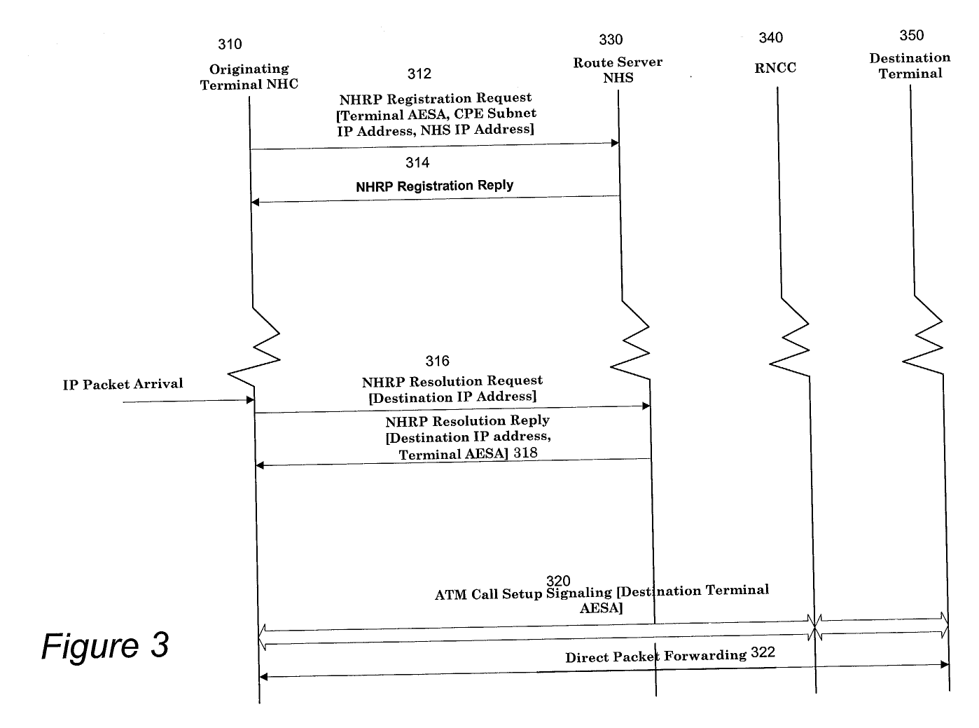

FIG. 3 illustrates the signaling and data forwarding flows that occur when the CPE router 245 and 252 forwards traffic for transport across the communications system. The NHC 310 at the originating terminal is shown to have previously completed the NHRP Registration process, i.e., the originating terminal NHC sends a NHRP registration request to the NHS 330 (as shown by 312) and the NHS sends a NHRP registration reply (as shown by 314), identifying the connected CPE router interface IP subnet address and the user terminal's ATM address. Variations on the registration are supported depending on the network's support for IP, including static configuration at the NHS 330 or the registration of multiple subnets behind the user terminal.

To support the IP-to-ATM address resolution, the NHS 330 associated with a particular RS will receive from that RS the IP routing table defined for each LNG. For each network address reachable across the LNG, the routing table will specify the next hop router IP address. The routing table may also include a default route to the gateway router, allowing for address resolution for destination addresses outside the LNG (e.g., the Internet). To associate the next hop router address with the corresponding user terminal ATM address, each user terminal will be required to register its ATM address (shown as 316) as well as the IP subnet address of the CPE interface to the its connected router. The NHS 330 will use the user terminal registration information in conjunction with the IP routing table to compile the address resolution table that allows each network IP address of a LNG to be mapped to a corresponding user terminal ATM address (as shown by 318). The address resolution table at the NHS 330 will also include the IP routing information that was manually configured at the RS. In those cases of static routing with dynamic address resolution, the user terminals will still perform the NHC registration providing both its assigned (default) address as well as its CPE interface subnet ATM address.

The NHRP will be responsible for updating and maintaining the validity of the address resolution information that is distributed and cached at user terminals across the system. Each address resolution response provided by the NHS 330 will have a timed validity period that will be automatically purged by the NHS 330 in the event that routing changes (provided through RS routing table updates) result in a topology change that affects the information provided to a user terminal.

Once a terminal has completed the address resolution process for a received IP packet, a new ATM virtual connection will be established across the satellite network if an appropriate connection to the particular ATM destination does not already exist (ATM call set-up signaling between the original user terminal and the NCC 340, as shown by 320). If an appropriate connection does exist or the new ATM virtual connection has been existed, the packet will be forwarded along the existing path (as shown in 322) to a destination user terminal 350. The Quality of Service (QoS) attributes associated with the established connection will be determined based on QoS provisions specified for the user terminal. This will occur outside of the routing and NHRP framework. For example, a connection admission control element of the satellite ATM network which applies a policy-based decision to each connection request across a user-network interface (UNI) to make such a determination.

Upon establishment of a virtual connection, IP data packets are encapsulated into ATM cells using ATM Adaptation Layer-Type 5 (AAL5) for transport across the virtual connection.

The separation of routing functionality from forwarding functionality in the resulting IP network is a natural result of this invention. The use of ATM and its control plane signaling protocol, with the addition of Route Server functionality and NHRP (or, alternatively, Classical IP over ATM or other similar technologies for address resolution), afford the same functionality for satellites that the emerging use of MPLS does for existing networks. Support of IP QoS by this invention is provided naturally because of the choice of ATM. An added strength of this approach, with ATM is chosen as the NBMA protocol, is that it brings to bear ITU Recommendation Q.2931 for Broadband ISDN signaling over the ATM user-network interface (UNI). This protocol is firmly based on ITU Recommendations Q.931 and Q.933 for signaling across, respectively, the Narrowband ISDN UNI and the Frame Relay UNI. Thus, in this choice, the control plane protocols are legacy protocols, are well-documented, and have years of use in core networks behind them. This mitigates the schedule and cost risk inherent in technically aggressive satellite-based packet switching solutions, especially in view of the rapidly evolving nature of Internet standards. Note further that the IETF provides for the use of ATM in this manner. The unique aspect of this invention is in the application to the case of a geographically-broad coverage, fast packet switch on board a geosynchronous satellite.

While specific embodiments of the invention have been described herein, it will be apparent to those skilled in the art that various modifications may be made without departing from the spirit and scope of the invention.

1. A distributed communication system comprising:
a user terminal for generating and processing user data in a connectionless format:
a relay node communicatively connected to the user terminal, the relay node supporting a connection-oriented operation functionality; and
a gateway communicatively connected to the relay node for managing the interface between the user terminal and the relay node.

2. The system of claim 1, wherein the user data includes data in an IP format.

3. The system of claim 1, wherein the relay node comprises an ATM switch

4. The system of claim 3, wherein the relay node is disposed in a geosynchronous satellite.

5. The system of claim 1, wherein the gateway comprises a route server.

6. The system of claim 1, wherein the gateway comprises a next hop server.

7. The system of claim 1, wherein the gateway comprises a router.

8. The system of claim 1, further comprising a router connected to the user terminal.

9. The system of claim 8, wherein the gateway comprises a route server which is operatively connected to the router.

10. The system of claim 8, wherein the router is connected to a network.
